(19) United States
(12) Patent Application Publication
(10) Pub. No.: US 2010/0213114 A1
(43) Pub. Date: Aug. 26, 2010

(54) SELF-CLEANING FILTRATION MACHINE WITH ROTARY DRUM FILTER FOR CONTAMINATED LIQUIDS

(75) Inventor: Carlo Pola, Lanzo Torinese (IT)

Correspondence Address: SCULLY SCOTT MURPHY & PRESSER, PC, 400 GARDEN CITY PLAZA, SUITE 300, GARDEN CITY, NY, 11530, US

(73) Assignee: LOSMA S.P.A., Curno (IT)

(21) Appl. No.: 12/678,444

(22) PCT Filed: Sep. 4, 2008
(86) PCT No.: PCT/EP2008/061674

§ 371 Date: Mar. 16, 2010

(30) Foreign Application Priority Data
Sep. 17, 2007 (IT) MI2007A001789

(51) Int. Cl. B01D 33/073; B01D 33/50; B03C 1/02; B01D 33/46

(52) U.S. Cl. 210/223; 210/402; 210/391; 210/392; 210/396; 210/393

(57) ABSTRACT

A self-cleaning filtration machine with rotary drum filter for filtering contaminated liquids, comprising at least one filtration device which is associated with the rotary drum, the filtration device being interposed between a contaminated liquid collection tank and a filtered liquid collection tank, the self-cleaning filtration machine comprising air suction means in order to generate a partial vacuum between the contaminated liquid collection tank and the filtered liquid collection tank.

### TECHNICAL FIELD

The present invention relates to a self-cleaning filtration machine with rotary drum filter for filtering contaminated liquids.

### BACKGROUND ART

Known filtration machines for filtering contaminated liquids comprise substantially a filtration device which is interposed between a tank for collecting the contaminated liquid and a tank for collecting the filtered liquid.

The flow of fluid that is established between the two tanks can occur by way of natural phenomena, for example by gravity, or by way of external means, which force the liquid to pass in the filtration device.

This passage often occurs thanks to the use of a pump which draws the filtered liquid from the filtered liquid collection tank, thus creating a negative difference between the two tanks and consequently forcing the passage of the contaminated liquid from the contaminated liquid collection tank to the filtered liquid collection tank through the filtration device.

Using pumps to create the partial vacuum described above is an expensive choice.

The insertion of a pump in a hydraulic system, such as for example the system for cleaning contaminated fluid, in fact entails a substantial expense, linked not only to the purchase of the pump but also linked to the technical measures related to the installation of such pump.

These measures are essential in order to reproduce the optimum operating conditions for the selected pump and prevent phenomena that damage such pump, such as for example cavitation.

Another drawback consists in that known machines are structurally very complicated and therefore are scarcely flexible in terms of possible variations in configuration after installation.

Another drawback of known machines, linked to their structural complexity, consists in that maintenance operations are very complicated and entail high maintenance costs.

### DISCLOSURE OF THE INVENTION

The aim of the present invention is to eliminate the drawbacks cited above by providing a self-cleaning filtration machine with rotary drum filter for contaminated liquids that uses technical solutions that do not require the use of pumps, thus reducing costs.

Within this aim, an object of the present invention is to provide a self-cleaning filtration machine with rotary drum filter for contaminated liquids, manufactured in such a manner to have from the outset the possibility to be fitted and subsequently modified in order to adapt it to installation and system requirements.

Another object of the present invention is to provide a self-cleaning filtration machine with rotary drum filter for contaminated liquids that allows simple and quick extraction of the components in order to perform maintenance operations.

This aim and these and other objects, which will become better apparent hereinafter, are achieved by a self-cleaning filtration machine with rotary drum filter for filtering contaminated liquids, comprising at least one filtration device which is associated with said rotary drum and is interposed between a contaminated liquid collection tank and a filtered liquid collection tank, characterized in that it comprises air suction means in order to generate a partial vacuum between said contaminated liquid collection tank and said filtered liquid collection tank.

### BRIEF DESCRIPTION OF THE DRAWINGS

Further characteristics and advantages of the present invention will become better apparent from the description of a preferred but not exclusive embodiment of a self-cleaning filtration machine with rotary drum filter for filtering contaminated liquids according to the invention, illustrated by way of non-limiting example in the accompanying drawings, wherein:

FIG. 1 is a top view of an embodiment of a self-cleaning filtration machine with rotary drum filter for filtering contaminated liquids according to the present invention;

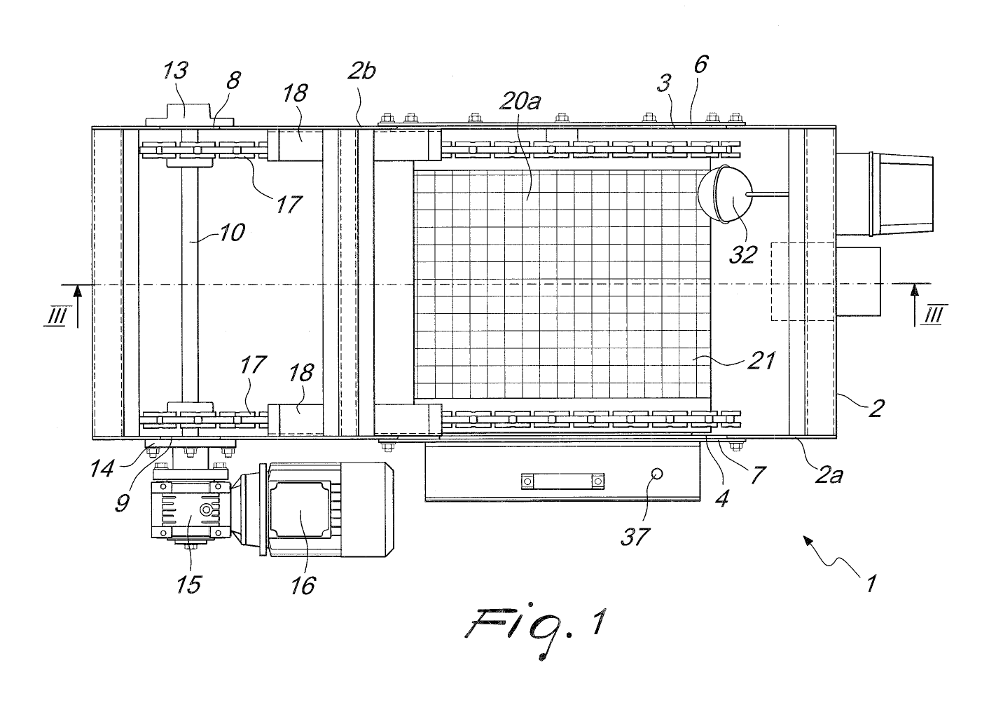

FIG. 2 is a partial rear sectional view of an embodiment of a filtration machine according to the present invention;

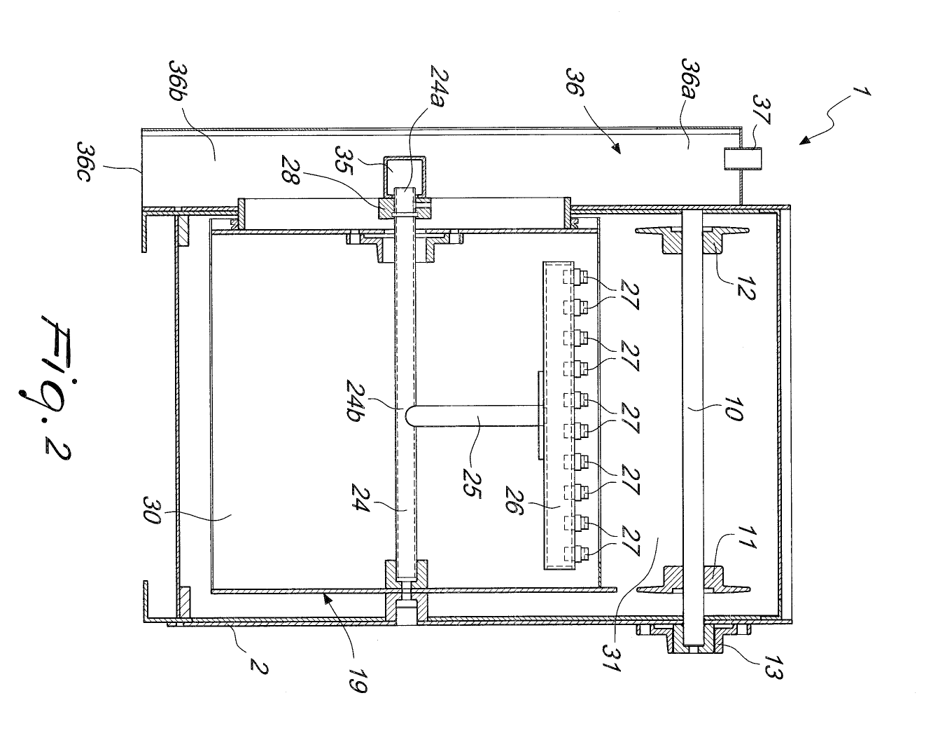

FIG. 3 is a sectional view, taken along the line III-III, of an embodiment of a filtration machine shown in FIG. 1;

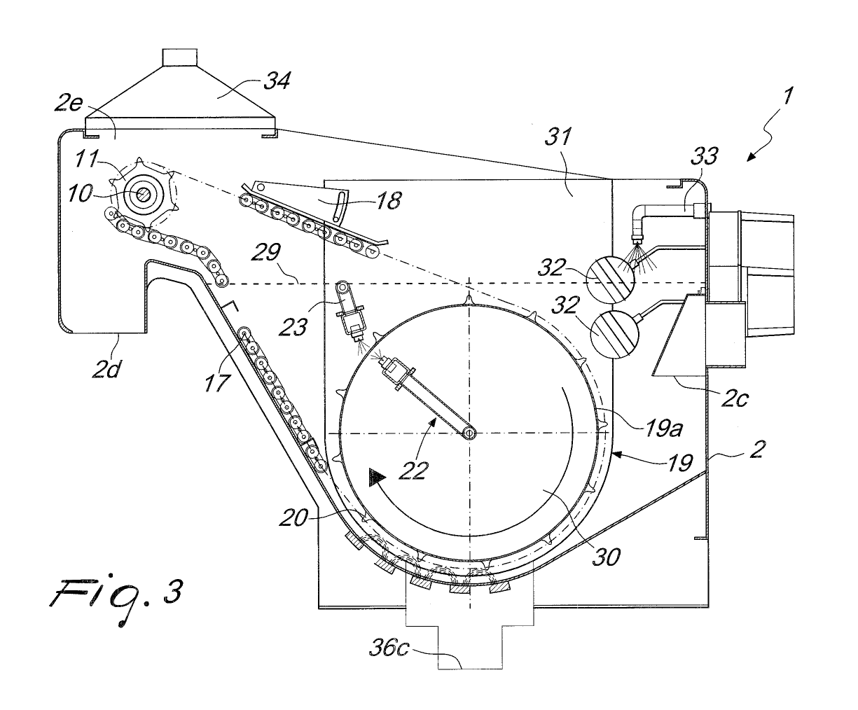

FIGS. 4 and 5 are two schematic side elevation views, respectively a right view and a left view, of an embodiment of a filtration machine according to the present invention.

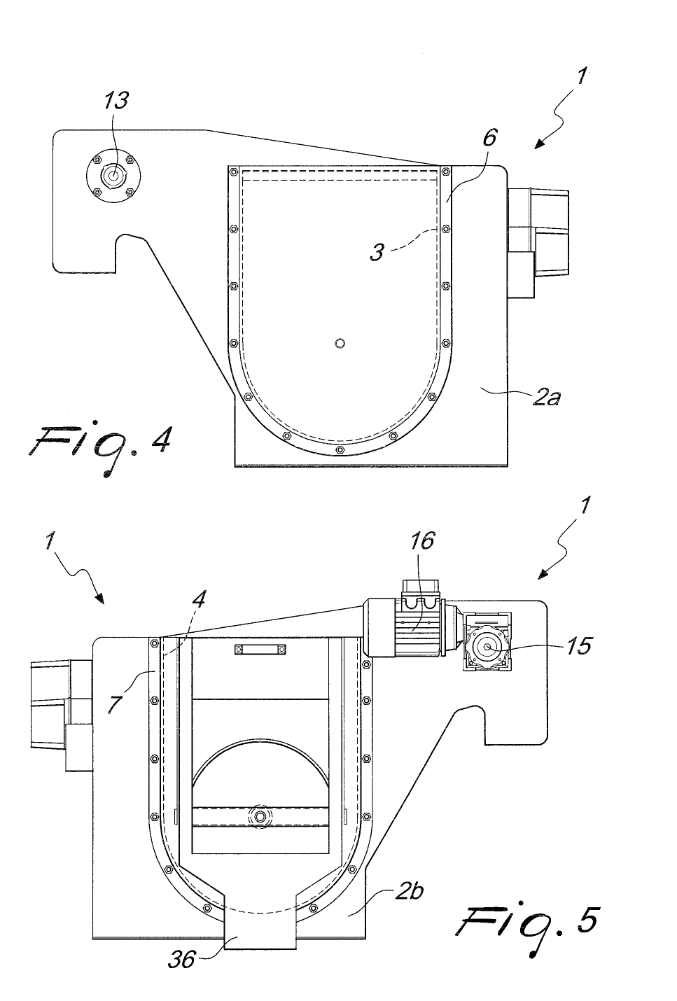

### WAYS OF CARRYING OUT THE INVENTION

With reference to the figures, an embodiment of the self-cleaning filtration machine with rotary drum filter for filtering contaminated liquids according to the invention, generally designated by the reference numeral 1, comprises a mechanical structure 2 which is perfectly symmetrical and has advantageously two symmetrical openings 3 and 4, respectively on a right side wall 2a and on a left side wall 2b.

Two perfectly interchangeable covers 6 and 7 are bolted respectively on the right side wall 2a and on a left side wall 2b.

The two covers 6 and 7 are substantially rectangular and both have a rounded end portion 5.

Two other openings 8 and 9 which are perfectly symmetrical and have a substantially circular shape are provided respectively on the right side wall 2a and on the left side wall 2b.

A driving shaft 10 is inserted in the openings 8 and 9, and at least two sprockets 11 and 12 are keyed thereon and are arranged inside the filtration machine 1 and respectively proximate to the two side walls 2a and 2b.

The driving shaft 10 is supported axially and radially by bearings, which are associated with two supporting flanges 13 and 14, which are bolted respectively to the side walls 2a and 2b.

The driving shaft 10 passes through the flange 14 to be then associated with a reduction unit 15, connected to motor means 16.

Two chains 17 are respectively partly wound around the two sprockets 11 and 12.

The two chains 17 are pretensioned by at least one pretensioning unit 18 and partly wind around a rotary drum 19 which is substantially cylindrical and has one or two pluralities of teeth 20 on the outer surface 19a and arranged proximate to the side walls 2a and 2b.

The outer surface 19a has a plurality of holes, substantially along its entire extension.

The rotary drum 19 is arranged between the two symmetrical openings 3 and 4 and is arranged substantially axially to the rounded end portion 5, so that the rotation axis of the rotary drum 19 is parallel and does not coincide with the rotation axis of the sprockets 11 and 12.

The rotary drum 19 can rotate about its own axis of rotation by way of the motor means 16.

A filtration device associated with the rotary drum 19 is interposed between the two chains 17.

The filtration device comprises at least one filtration mesh 21, which wraps completely around the outer surface 19a of the rotary drum 19.

The filtration machine 1 comprises a device 22 for cleaning in countercurrent the filtration mesh 21 and a device 23 for cleaning along the filtration direction.

The countercurrent cleaning device 22 and the device 23 for cleaning along the filtration direction each comprise a main manifold 24, which is connected at its end 24a to a duct 35 which belongs to the washing system.

A secondary manifold 25 is connected in a central portion 24b of the main manifold 24, and is connected in turn to a nozzle holder 26, which bears a plurality of nozzles 27 which spray clean liquid toward the filtration mesh 21.

The components of the countercurrent cleaning device 22 and of the device 23 for cleaning along the filtration direction are installed strictly hermetically; more precisely, there are sealing rings, for example of the O-ring type, between the several components.

The main manifold 24 of the countercurrent cleaning device 22 acts as a rotation shaft for the rotary drum 19 and is associated, at one of its ends 24a, for example by means of a bayonet coupling with a positioning notch, with a supporting element 28 arranged on the cover 6.

The rotary drum 19 delimits internally a filtered liquid collection tank 30, which is separated from a contaminated liquid collection tank 31, which is arranged outside the rotary drum 19.

In the contaminated liquid collection tank 31 there is at least one level monitoring device 32 in order to detect a preset level 29 of the contaminated liquid.

The level monitoring device 32 is provided advantageously with a self-cleaning device 33.

In the contaminated liquid collection tank 31 there is advantageously a magnetic device 34, which is arranged conveniently proximate to the bottom of the tank 31 in order to attract magnetically the contaminants that have ferromagnetic properties.

The structure 2 comprises an inlet 2c, which is arranged laterally with respect to the rotary drum 19 and on which the contaminated liquid intake is installed.

The structure 2 comprises an opening 2d for discharging the contaminants into a collection tank arranged outside the filtration machine 1.

The structure 2 comprises advantageously a suction port 2e, which is arranged above the driving shaft 10 and on which air suction devices 34 are installed in order to aspirate any polluting emissions that originate from the processed fluid.

A chamber 36 which is external to the filtration machine 1 is installed on the cover 7, and an intake 37 is provided on the upper portion 36a of the chamber 36 in order to connect air suction means.

The air suction means can comprise for example at least one air extractor or one Venturi extractor or a system with a siphon and communicating vessels.

An outlet 36c for discharging the filtered liquid is provided on the lower portion 36b of the chamber 36.

With reference to the figures, operation of the self-cleaning filtration machine with rotary drum filter for filtering contaminated liquids according to the present invention is as follows.

In conditions of normal use, the contaminated liquid is introduced in the contaminated liquid collection tank 31 through the inlet 2c; due to a difference in pressure between the contaminated liquid collection tank 31 and the filtered liquid collection tank 30, the contaminated liquid is filtered by the filtration mesh 21, passing from the contaminated liquid collection tank 31 to the filtered liquid collection tank 30.

The partial vacuum in the filtered liquid collection tank 30 is generated by the air suction means, which by aspirating air generate the partial vacuum.

When the filtration mesh 21 becomes saturated with the contaminated substances, the level of the liquid in the contaminated liquid collection tank 31 rises until it reaches the preset level 29 of the contaminated liquid, so that it is detected by the level monitoring device 32.

The level detection device 32, once the preset level 29 of contaminated liquid has been detected, operates the motor means 16, which turn the rotary drum 19, while the countercurrent cleaning device 22 and the device for cleaning along the filtration direction 23 spray clean liquid in countercurrent with respect to the filtration mesh 21 respectively from the inside outwardly and from the outside inwardly.

The contaminants, also in combination with the action of the magnetic device 34 that attracts ferromagnetic contaminants, separate from the filtration mesh 21 to be deposited on the bottom of the tank 31 and then are conveyed outside toward the opening 2d to be deposited in a collection tank by means of scrapers 39 connected to the chains 17.

As already mentioned, the rotary drum is actuated when the level sensing device 32 detects the preset level, but can also rotate continuously or in a timer-controlled manner.

In practice it has been found that the self-cleaning filtration machine with rotary drum filter for filtering contaminated liquids according to the present invention fully achieves the intended aim and objects, since it does not use pumps to create the partial vacuum between the two tanks.

The filtration machine according to the invention provides from the outset the possibility to be assembled and modified, after its design, in order to adapt it to installation and system requirements.

The filtration machine according to the invention does not require particular installation equipment.

Another advantage achieved by the present filtration machine consists in that it is easy to maintain, since all its components can be extracted easily.

The self-cleaning filtration machine with rotary drum filter for contaminated liquids thus conceived is susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to requirements and to the state of the art.

The disclosures in Italian Patent Application No. MI2007A001789 from which this application claims priority are incorporated herein by reference.

1-17. (canceled)

18. A self-cleaning filtration machine with rotary drum filter for filtering contaminated liquids, comprising at least one filtration device which is associated with said rotary drum and is interposed between a contaminated liquid collection tank and a filtered liquid collection tank, further comprising air suction means in order to generate a partial vacuum between said contaminated liquid collection tank and said filtered liquid collection tank.

19. The self-cleaning filtration machine according to claim 18, wherein said air suction means comprise at least one air extractor.

20. The self-cleaning filtration machine according to claim 18, wherein said air suction means comprise at least one Venturi extractor.

21. The self-cleaning filtration machine according to claim 18, wherein said air suction means comprise at least one system with a siphon and communicating vessels.

22. The self-cleaning filtration machine according to claim 18, wherein said filtration device comprises at least one filtration mesh, which is wrapped totally on the outer surface of said rotary drum.

23. The self-cleaning filtration machine according to claim 22, wherein said filtered liquid collection tank is internal to said rotary drum and is delimited by the inner surface of said rotary drum.

24. The self-cleaning filtration machine according to claim 18, further comprising at least one device for monitoring the level of the liquid which is adapted to detect a preset level of contaminated liquid in said contaminated liquid collection tank.

25. The self-cleaning filtration machine according to claim 22, further comprising at least one device for cleaning said filtration mesh in countercurrent.

26. The self-cleaning filtration machine according to claim 25, further comprising at least one device for cleaning said filtration mesh along the filtration direction.

27. The self-cleaning filtration machine according to claim 25, wherein said countercurrent cleaning device is arranged in said filtered liquid collection tank and is fixed with respect to said contaminated liquid collection tank.

28. The self-cleaning filtration machine according to claim 26, wherein said device for cleaning along the filtration direction is arranged in said contaminated liquid collection tank and comprises a plurality of nozzles that spray clean liquid in the direction of said filtration mesh.

29. The self-cleaning filtration machine according to claim 26, wherein said countercurrent cleaning device and said device for cleaning along the filtration direction each comprise a plurality of nozzles which spray clean liquid in the direction of said filtration mesh.

30. The self-cleaning filtration machine according to claim 18, wherein said rotary drum can rotate about its own axis by way of transmission means connected to motor means.

31. The self-cleaning filtration machine according to claim 30, wherein said transmission means comprise at least one chain, which engages partly on a plurality of teeth of said rotary drum and partly on a pinion which is keyed on a shaft associated with said motor means.

32. The self-cleaning filtration machine according to claim 31, further comprising scraper means for said chain.

33. The self-cleaning filtration machine according to claim 22, further comprising magnetic attraction means which are associated with said contaminated liquid collection tank proximate to said filtration mesh.

34. The self-cleaning filtration machine according to claim 18, further comprising an opening for discharging contaminants into a collection tank.
